(19) United States
(12) Patent Application Publication
(10) Pub. No.: US 2005/0028191 A1
(43) Pub. Date: Feb. 3, 2005

(54) Content control system

(76) Inventors: Gary E. Sullivan, Trabuco Canyon, CA (US); Kim C. Smith, Austin, TX (US); Mark D. Goddard, Rancho Santa Margarita, CA (US); Frank Liebenow, Jefferson, SD (US); Robert A. Boger, Sioux City, IA (US)

Correspondence Address: Gateway, Inc.;Law Department, MS Y04, 610 Gateway Drive, Box 2000, N. Sioux City, SD, 57049-2000, US

(21) Appl. No.: 10/876,376

(22) Filed: Jun. 24, 2004

Related U.S. Application Data
(63) Continuation-in-part of application No. 10/629,966, filed on Jul. 30, 2003.
Application No. 10/629,966 is a continuation of application No. 09/375,692, filed on Aug. 17, 1999, now Pat. No. 6,662,365.
(63) Continuation-in-part of application No. 10/732,098, filed on Dec. 10, 2003.
Application No. 10/732,098 is a continuation of application No. 09/464,275, filed on Dec. 15, 1999, now Pat. No. 6,684,240.

(51) Int. Cl. H04N 7/025; H04H 9/00; H04N 7/16

(52) U.S. Cl. 725/28; 725/25; 725/20; 725/32; 348/461

(57) ABSTRACT

A content control system for limiting access by sensitive users, such as children, or the like, to certain types of content. The content control system provides a user interface for an information handling system, information appliance, content recorder, or the like that provides a single point of user control for parental locks for multiple audio and/or audiovisual devices. In embodiments of the invention, the content control system may employ a method of setting the content rating parameters of a content control system based on content rating of example content. The content control system may also employ a method for modifying the content rating of content received by a content recorder such as a personal video recorder, or the like.

### CROSS-REFERENCE TO RELATED APPLICATIONS

The present application is a Continuation-in-Part of U.S. patent application Ser. No. 10/629,966, filed Jul. 30, 2003, which is a Continuation of U.S. patent application Ser. No. 09/375,692, filed Aug. 17, 1999. The present application is also a Continuation-in-Part of U.S. patent application Ser. No. 10/732,098, filed Dec. 10, 2003, which is a Continuation of U.S. patent application Ser. No. 09/464,275, filed Dec. 15, 1999. Said U.S. patent application Ser. Nos. 10/732,098, 10/629,966, 09/464,275, and 09/375,692 are hereby incorporated by reference in their entirety.

### FIELD OF THE INVENTION

The present invention generally relates to content control systems for limiting access by sensitive users, such as children, or the like, to certain types of content. More specifically, the present invention relates to a user interface for an information handling system, information appliance, content recorder, or the like that provides a single point of user control for parental locks for multiple audio and/or audiovisual devices, and to a method of setting the content rating parameters of a content control system based on content rating of example content. The present invention also specifically relates to a method for modifying the content rating of content received by a content recorder such as a personal video recorder, or the like.

### BACKGROUND OF THE INVENTION

The exposure of children to inappropriate material, such as sexual content, violence, coarse language, and the like, in media such as television, radio, and the Internet has become a great concern. Recent technological developments allow greater parental control of material to which children are exposed. For example, many televisions now include devices that decode program rating data encoded into a program at the time it is broadcast to selectively pass or block television programming based on the rating level set. Similarly, software programs have been developed that block access to Internet material containing content that may be deemed inappropriate for young children.

Such content control technologies potentially eliminate the need for content censorship, thus providing greater freedom of expression for broadcasters, Web page authors, and the like, while providing an opportunity for parents to control, even in their absence, children's access to media content according to their own values and child rearing philosophy. However, because existing content control systems place the responsibility of protecting children from viewing inappropriate material with parents, even the most fail-safe of parental control technologies will be of little value if parents are unable or unwilling to exercise this responsibility.

A major reason parents fail to effectively use existing content control systems to block objectionable content is the confusing nature and variety of ratings utilized by existing ratings schemes. For example, television broadcasts may use MPAA (Motion Picture Association of America) rating schemes having ratings such as G, PG, PG-13, R, and/or broadcast television rating (TV rating) schemes having ratings such as TV-Y, TV-Y7, TV-Y7-FV, TV-G, TV-PG, TV-14, TV-MA. In some TV rating schemes, a “fantasy violence” (FV) indicator may be added to the TV-Y rating, and indicators for violence (V), sexual situations (S), language (L), and dialog (D), may be added to each of the TV-PG, TV-14, and TV-MA ratings. In addition to blocking individual programs based on ratings, television locking systems also provide channel locks. Similarly, DVD rating systems may employ a numbered rating system, for example, a scale from 1-10, with associated MPAA ratings. Internet blocking software, while not yet utilizing an established rating system, nevertheless classify Internet material by content themes such as course language, inappropriate sexual content, violence, or the like. Parents may be confused by this myriad of rating systems and may not fully understand what ratings of such systems represent or how they are applied to the content. Further, the type of content encompassed by the ratings of such ratings schemes is subject to change over time as societal values change. Thus, a rating given to existing content may in the future become inappropriate for that content. For instance, a television program employing a TV ratings scheme may be assigned a TV-G rating even though it contains a limited amount of mild violence. However, future events may dictate that exposure of children to violent content of any kind is undesirable, and should result in such content warranting a TV-PG rating. A parent wishing to block content containing any violence may thus block content having ratings equal to or exceeding TV-PG. If the television program is thereafter rebroadcast without adjustment of its rating, the parent may be surprised to find that the program is not blocked as expected because of its violent content, due to its original TV-G rating.

Because various media employ different rating schemes and different user interfaces, and because the meaning of ratings utilized in such schemes may change over time, use of parental locking systems may be confusing. In some instances, a user may believe that certain rating levels may prevent access to objectionable subject matter when in fact such objectionable subject matter is passed. As additional rating schemes become more commonplace, such as electronic program guide (EPG) or DSS ratings, digital television (DTV) ratings, Web page ratings, and the like, it is probable that use of content control systems to filter content will become more and more difficult because of the confusing nature of the various ratings schemes and the lack of knowledge of what ratings of such schemes represent. Consequently, a user such as a parent or the like may feel that a content rating for content the user has viewed may not be stringent enough, or conversely, too stringent, for sensitive users such as children, for whom access to the content is controlled by the user.

Therefore, there exists a need for a system and method that provide simplified control of parental lock settings for audio and/or audiovisual devices in an audiovisual system. Further, there exists a need for a content control system capable of allowing a user to set acceptable content rating parameters for filtering media content, wherein the user in not required to have specific knowledge of the content ratings schemes used by the media, or the meaning of content ratings within the ratings scheme. Still further, there exists a need for a content control system that allows a user to modify the content rating of media recorded by a content recorder as the user sees fit.

### SUMMARY OF THE INVENTION

The present invention is directed to a content control system and methods employed by a content control system for limiting access by sensitive users, such as children, or the like, to certain types of content.

In one embodiment, the present invention is a system or method for controlling one or more, and preferably two or more, parental control subsystems within an entertainment system. Although the invention will be described herein in terms of “parental control” or “parental locks,” it should be recognized that such terms are intended to encompass any other person, in addition to parents who desire to prevent access of children to inappropriate audiovisual content, such as administrators of computers or networks available to the public, such as in libraries, on display in a retail environment, and so forth, or persons who display A/V material where children may be present, such as in-flight movies displayed on an aircraft, and so forth. The system includes a computer interfaced to an audio and/or audiovisual device having a native parental control subsystem or locking mechanism having adjustable parameters. In a preferred embodiment, the system includes a computer interfaced to a plurality of audio and/or audiovisual devices, wherein at least two of the audio and/or audiovisual devices comprise a native parental control subsystem or locking mechanism having adjustable parameters. A software locking mechanism operates the computer to allow a user to input one or more general parental control parameters and then sets the adjustable parameters of each native parental control subsystem within the system by mapping the parental control parameters onto each separate, native mechanism for each device.

In a second embodiment, the present invention provides a method of setting content rating parameters of a content control system. Employing the present method, a user may set acceptable content rating parameters based on the rating of example content by blocking or unblocking the example content. The content ratings system compares the content rating of the example content with existing acceptable content rating parameters and adjusts the content rating parameters accordingly. In this manner, specific knowledge of the content ratings scheme employed, or the meaning of specific content ratings used by the content ratings scheme, is not required.

In a third embodiment, the present invention is directed to a method for modifying the content rating of content received by a content recorder such as a personal video recorder, or the like, for controlling access to content recorded via the content recorder. In exemplary embodiments, the method comprises receiving content having a first content rating associated therewith for controlling access to the content; storing the content and the associated first content rating; receiving a request to change the first content rating to a second content rating; and storing the second content rating so that the second content rating is associated with the content for controlling access to the content.

In embodiments of the invention, the disclosed methods may be implemented as programs of instructions executable by one or more information appliances including but not limited to digital information appliances, information handling systems, televisions, or content recorders such as personal video recorders (PVR), DVD players/recorders, VCR devices, and the like. The program of instructions when executed causes the information appliance to perform the steps of the method.

Although the present invention will be described primarily in reference to TV broadcast ratings and MPAA motion picture ratings, it will be recognized that the present invention is not limited to the particular ratings systems or ratings locks described below and illustrated in the drawing figures. Other ratings include, for example, DVD ratings, electronic program guide (EPG) ratings such as Telstar, EchoStar, or other EPG systems, digital television (DTV) ratings, or any other ratings standards as are now available or as may become available in the future. It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 shows a hardware system in accordance with the present invention;

FIG. 2 shows an exemplary display screen layout of a control panel which may be used to control the audiovisual devices of a system according to the present invention;

FIGS. 3 and 4 illustrate dual overlays of a parental lock interface according to one embodiment of the present invention;

FIGS. 5 and 6 illustrate dual overlays of a parental lock interface according to another embodiment of the present invention;

FIG. 7 illustrates an embodiment of a parental lock interface overlay providing optional “context” information;

FIG. 8 illustrates a content rating lock overlay having separate television and movie rating fields;

FIG. 9 is a flow chart illustrating a method according to the present invention;

FIGS. 10A and 10B are a flow chart outlining a method according to the present invention accommodating multiple user profiles;

FIG. 11 shows the display screen of an exemplary information appliance, wherein the display screen provides an exemplary user interface suitable for implementing the present invention;

FIG. 12 is a perspective view of an information appliance wherein the present invention is implemented as a button or switch of a control panel disposed on the housing of an information appliance;

FIG. 13 is a flow diagram illustrating a method of setting acceptable content rating parameters based on example content in accordance with an exemplary embodiment of the present invention;

FIGS. 14A and 14B illustrate lock confirmation windows according to one embodiment of the present invention;

FIG. 15 illustrates a lock confirmation window according to an embodiment of the present invention accommodating multiple user profiles;

FIG. 16 is a flow diagram illustrating a method of controlling access to content in accordance with an exemplary embodiment of the present invention; and

FIG. 17 is a flow diagram illustrating a method of controlling access to content via a content recorder in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

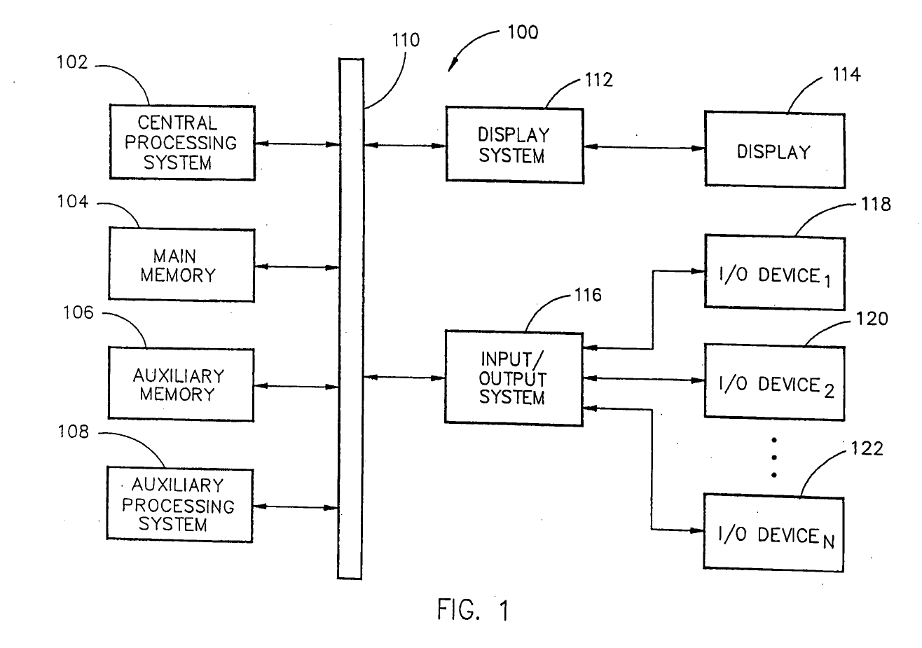

Referring now to FIG. 1, a hardware system in accordance with the present invention is shown. The hardware system 100 shown in FIG. 1 is generally representative of the hardware architecture of a computer-based information handling system of the present invention. The hardware system 100 is controlled by a central processing system 102. The central processing system 102 includes a central processing unit such as a microprocessor or microcontroller for executing programs, performing data manipulations and controlling the tasks of the hardware system 100. Communication with the central processor 102 is implemented through a system bus 110 for transferring information among the components of the hardware system 100. The bus 110 may include a data channel for facilitating information transfer between storage and other peripheral components of the hardware system. The bus 110 further provides the set of signals required for communication with the central processing system 102 including a data bus, address bus, and control bus. The bus 110 may comprise any state of the art bus architecture according to promulgated standards, for example industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and so on. Other components of the hardware system 100 include main memory 104, and auxiliary memory 106. The hardware system 100 may further include an auxiliary processing system 108 as required. The main memory 104 provides storage of instructions and data for programs executing on the central processing system 102. The main memory 104 is typically semiconductor-based memory such as dynamic random access memory (DRAM) and/or static random access memory (SRAM). Other semi-conductor-based memory types include, for example, synchronous dynamic random access memory (SDRAM), Rambus dynamic random access memory (RDRAM), ferroelectric random access memory (FRAM), and so on. The auxiliary memory 106 provides storage of instructions and data that are loaded into the main memory 104 before execution. The auxiliary memory 106 may include semiconductor based memory such as read-only memory (ROM), programmable read-only memory (PROM), erasable programmable read-only memory (EPROM), electrically erasable read-only memory (EEPROM), or flash memory (block oriented memory similar to EEPROM). The auxiliary memory 106 may also include a variety of nonsemiconductor-based memories, including but not limited to magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), etc. Other varieties of memory devices are contemplated as well. The hardware system 100 may optionally include an auxiliary processing system 108 which may be an auxiliary processor to manage input/output, an auxiliary processor to perform floating point mathematical operations, a digital signal processor (a special-purpose microprocessor having an architecture suitable for fast execution of signal processing algorithms), a back-end processor (a slave processor subordinate to the main processing system), an additional microprocessor or controller for dual or multiple processor systems, or a coprocessor. It will be recognized that such auxiliary processors may be discrete processors or may be built in to the main processor.

The hardware system 100 further includes a display system 112 for connecting to a display device 114, and an input/output (I/O) system 116 for connecting to one or more I/O devices 118, 120, up to N number of I/O devices 122. The display system 112 may comprise a video display adapter having all of the components for driving the display device, including video memory, buffer, and graphics engine as desired. Video memory may be, for example, video random access memory (VRAM), synchronous graphics random access memory (SGRAM), windows random access memory (WRAM), and the like. The display device 114 may comprise a cathode ray-tube (CRT) type display such as a monitor or television, or may comprise an alternative type of display technology such as a projection-type display, liquid-crystal display (LCD), light-emitting diode (LED) display, gas or plasma display, electroluminescent display, vacuum fluorescent display, cathodoluminescent (field emission) display, plasma-addressed liquid crystal (PALC) display, high gain emissive display (HGED), and so forth. The input/output system 116 may comprise one or more controllers or adapters for providing interface functions between the one or more I/O devices 118-122. For example, the input/output system 116 may comprise a serial port, parallel port, universal serial bus (USB) port, IEEE 1394 serial bus port, infrared port, network adapter, printer adapter, radio-frequency (RF) communications adapter, universal asynchronous receiver-transmitter (UART) port, etc., for interfacing between corresponding I/O devices such as a keyboard, mouse, trackball, touchpad, joystick, trackstick, infrared transducers, printer, modem, RF modem, bar code reader, charge-coupfed device (CCD) reader, scanner, compact disc (CD), compact disc read-only memory (CD-ROM), digital versatile disc (DVD), video capture device, TV tuner card, touch screen, stylus, electroacoustic transducer, microphone, speaker, audio amplifier, etc. The input/output system 116 and I/O devices 118-122 may provide or receive analog or digital signals for communication between the hardware system 100 of the present invention and external devices, networks, or information sources. The input/output system 116 and I/O devices 118-122 preferably implement industry promulgated architecture standards, including Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. It should be appreciated that modification or reconfiguration of the hardware system 100 of FIG. 1 by one having ordinary skill in the art would not depart from the scope or the spirit of the present invention.

In one embodiment, the hardware system 100 may be what is often called a PC-TV or a convergence system, so named because such systems represent the convergence of computer and consumer electronics into a single system. Alternately, the hardware system, or portions thereof, may be part of an information appliance providing a specific media. Examples of such appliances include televisions, VCR devices, DVD devices, Web TV devices, satellite receivers, cable boxes and the like.

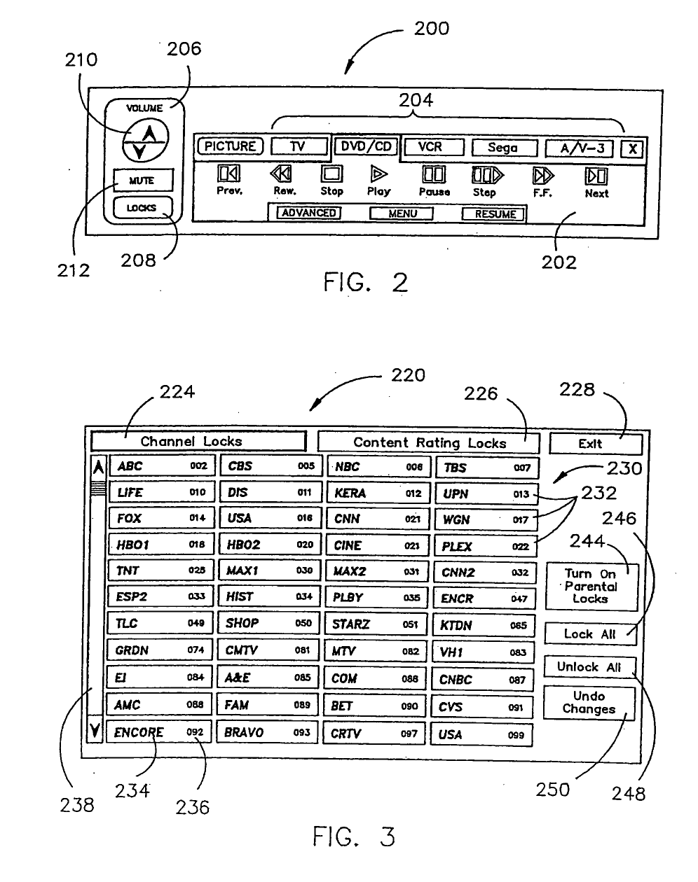

FIG. 2 shows an exemplary display screen layout 200 of a control panel which may be used to control the audiovisual devices of the system 100. A region or window 202 contains therein various control buttons or switches such as stop, play, rewind, fast forward, and so forth, which function as on-screen visual representations of actual functions of the particular A/V device selected. A means for selecting a particular A/V device to control may also be provided. In the illustration shown, the means selecting a particular A/V device is series of buttons 204, which, when selected, will change the contents of region or window 202 so that the controls illustrated correspond to and control the actual controls for the attached A/V device. As used herein, any on-screen graphical object which is described as a button or otherwise said to be selectable or otherwise accessed is intended to refer to on-screen objects which may be advantageously be controlled with a pointing device such as a mouse or other device for controlling an on-screen pointer or cursor and generating mouse button events, although it will be recognized that many of such objects may also be made accessible through keyboard input as well.

In the embodiment shown, the button 204 corresponding to DVD/CD is selected, with the controls therefor displayed in region 202. Highlighting, color differentiation, or other visual indicia may be provided to show the device selected. It will be recognized that other methods for selecting the A/V device may be provided, such as a menu hierarchies, pull down menus, pop up lists, radio button or check box lists, and so forth. In the event that there are additional A/V devices to be displayed in series 204, any conventional method may be employed, such as providing a scroll bar, resizing the size of layout 200, button resizing, providing additional rows, etc., as necessary, to accommodate the number of devices present.

The embodiment of FIG. 2 further contains a region 206 which contains controls common to all of the A/V devices, such as volume and mute buttons which control the overall sound output of the system. Also present within region 206 is the parental locks button 208. The locks button 208 is illustrated in region 206 to indicate that it is a generally applicable control rather than a device specific control, i.e., generally applicable to each device supporting the use of parental locks. It will be recognized that in implementing the generally applicable locking mechanism according to the present invention, it is not necessary to eliminate device specific parental lock software that may be provided nor is the present invention intended to preclude a user from individually adjusting each individual A/V device separately if a user so chooses. It will further be recognized that the present invention is not limited to any particular layout, and that the control panel 200 of FIG. 2 is provided merely to illustrate a preferred method of providing convenient user access to the parental locking system according to the present invention, and any other method of accessing the software may be provided, including via other software application or operating system environment. For example, other A/V control panel or media player software interfaces may be adapted to provide access to the generally applicable parental lock control in accordance with the present invention. Also, the present invention may also be implemented as a stand alone parental lock software application, utility, or control panel.

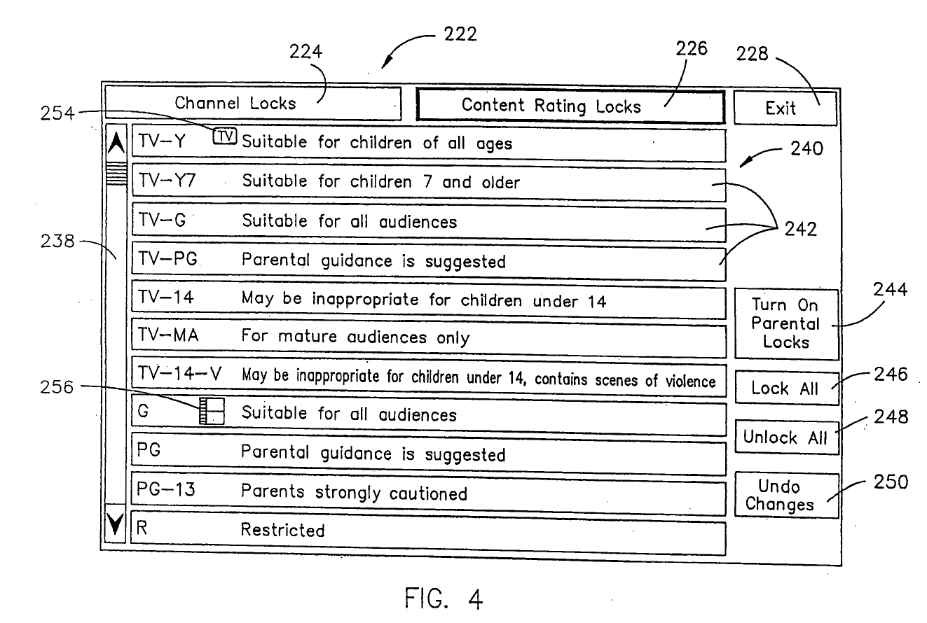

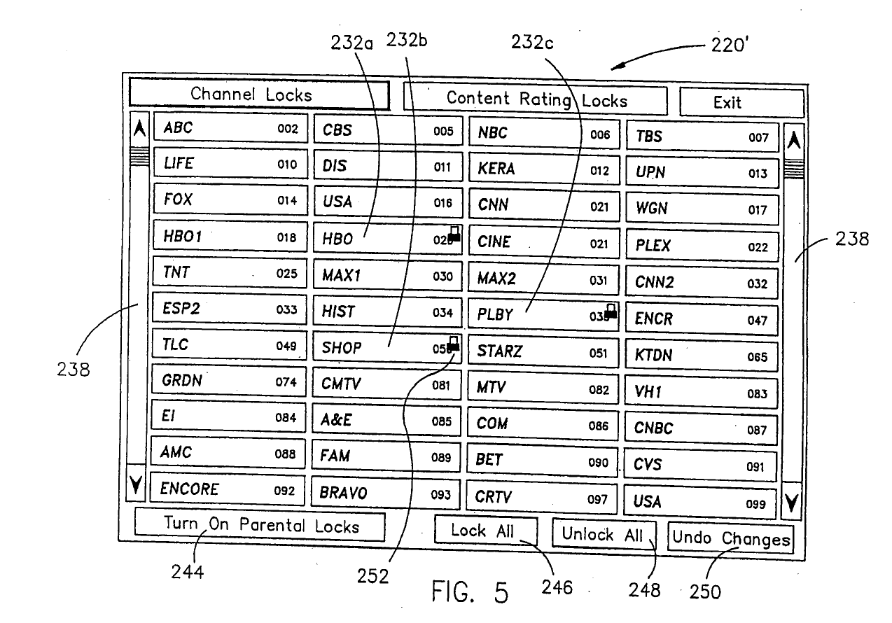

When the parental locks feature is accessed by a user, e.g., by selecting locks button 208, a parental locks interface such as that illustrated in FIGS. 3 and 4, is displayed. In one embodiment, an input dialog box will first appear requiring a password to be input prior to accessing the parental lock interface. In other embodiments, a password may not be required until an attempt is made to alter the settings of the A/V devices. In still other embodiments, the parental lock password may be required upon opening the A/V control panel, in which case the lock button 208 (FIG.2) would only appear, or would only be functional, when the correct password is entered. FIG. 3 illustrates one overlay 220 of a preferred dual overlay parental lock interface according to the present invention, with the second overlay 222 being illustrated in FIG. 4. Overlays 220 and 222 present channel lock button 224, which is highlighted (or otherwise made visually distinguishable) in FIG. 3 to indicate that it is the selected overlay. Likewise, content rating lock button 224 is highlighted (or otherwise made visually distinguishable) in FIG. 4, to indicate that the channel lock overlay is selected. Buttons 224 and 226 allow the user to toggle between the channel lock display screen 220 and the content rating lock display screen 222. An exit button 228 is provided to exit the program. In one embodiment, the exit button returns the user to the software environment that was used to access the parental locks interface, such as an A/V control panel or media player interface of the type illustrated in FIG. 2.

Referring now to FIG. 3, the majority of the channel lock overlay 220 is dedicated to field 230 of channel cells 232. In each channel cell there is a channel identifying field 234 and a channel number field 236. The channel identifying field contains channel identifying indicia such as one or more of the channel number, channel call letters, channel name, and the like. In other embodiments, the channel logo may be depicted in the channel identifying field, for example, as each channel cell's sole channel identifying indicium, or, in addition to one or more of channel number, channel call letters, channel name, and so forth. In the channel lock overlay, a user may select particular channels to lock and unlock, for example, wherein clicking on a particular channel cell toggles that channel between a locked and unlocked state. Preferably, the indicia within the cells of locked channels will be distinguishable from unlocked channels. In the event that the number of channels available is greater than the number of channel cells 232 that may be displayed within the channel lock overlay 220, a scroll bar 238 may be provided to allow a user to bring additional channels into view in field 230.

Content rating button 226 brings up content rating overlay 222. Referring now to FIG. 4, the majority of the content rating lock overlay 222 is dedicated to field 240 of rating cells 242. Each rating contains a TV or movie rating and a brief description of the rating. In the content rating lock overlay, a user may select particular ratings to lock and unlock. In one embodiment, clicking on a particular rating cell toggles that rating between a locked and unlocked state. Preferably, the indicia within the cells of locked ratings will be distinguishable from unlocked ratings. Since the number of ratings available will generally be greater than the number of rating cells 242 that may be displayed clearly within the content rating lock overlay 222, a scroll bar 238 may be provided to allow a user to bring additional rating cells into window 222.

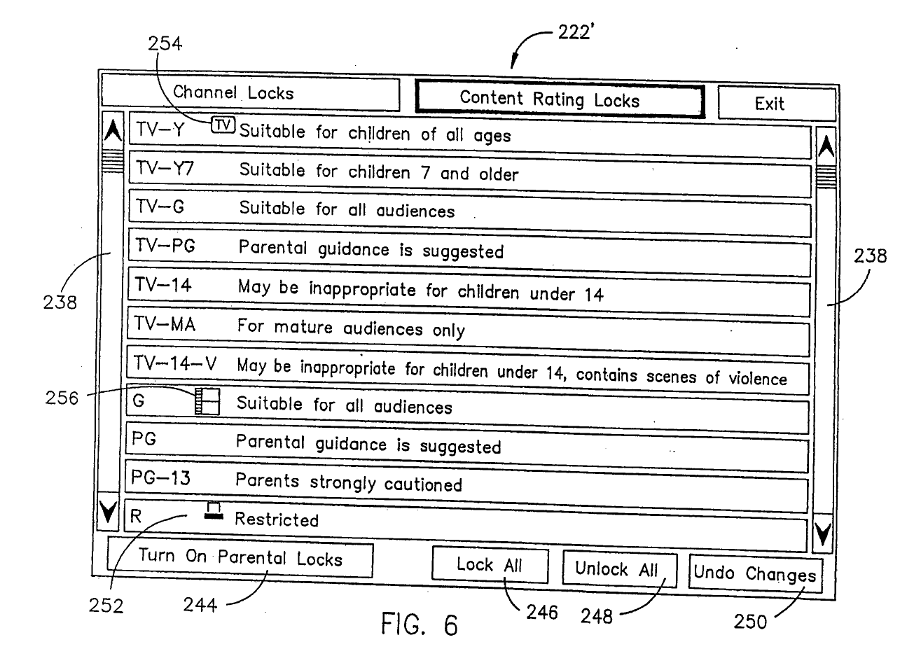

Referring now to FIGS. 3 and 4, buttons 244-250 are provided for applying the parental lock settings to each device. A button 244 is provided to turn on parental locks after a user's selections have been made by mapping a user's selections to each native parental control subsystem. A lock all button 246 for locking all devices and an unlock all button 248 for removing all locks may be provided. A user's previous settings may be saved in memory and an undo button 250 may be provided that allows a user to discard any changes made and to reinstate earlier settings. If a password was not required to access the parental lock interface itself, a dialog box requiring entry of a password may be provided when the user selects one of buttons 244-250. FIG. 5 shows an alternate channel lock overlay 220′, similar to the embodiment shown in FIG. 3, wherein buttons 244-250 are located at the bottom of overlay 220′. Likewise, FIG. 6 shows an alternate content rating lock overlay 222′, similar to the embodiment shown in FIG. 4, wherein buttons 244-250 are located at the bottom of overlay 222′.

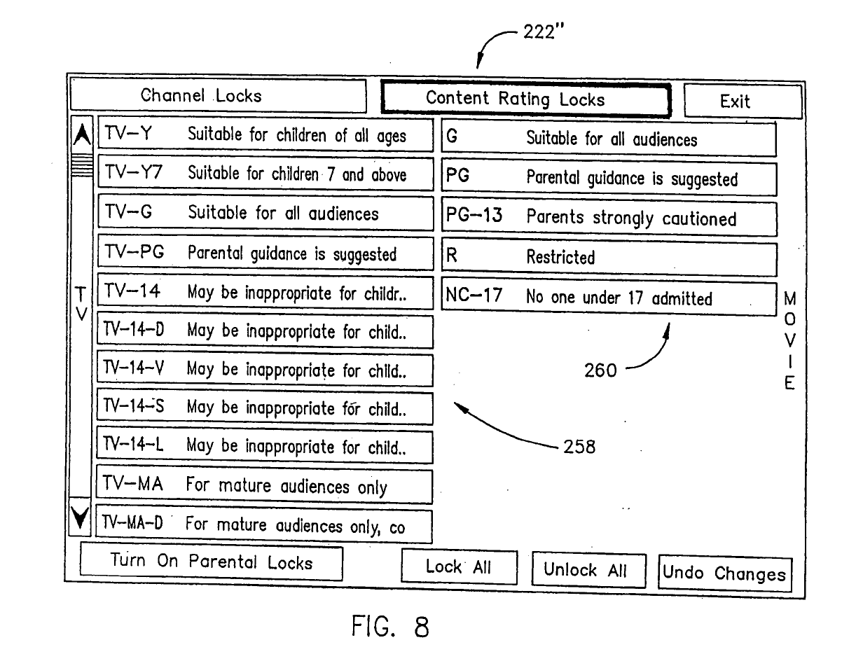

FIGS. 5 and 6 also depict an embodiment providing a visual indication of the channels and ratings that have been selected to be locked. Channel cells 232a, 232b, and 232c, are illustrated in FIG. 5 with optional padlock icon 252 appearing therein. In FIG. 6, the R rating is shown in a similar manner as being locked. Any manner of differentiating locked channels from unlocked channels and locked ratings from unlocked ratings may be employed, either as an alternative or in addition to a graphic or iconic indication such as padlock icon 252. Exemplary methods (not shown) include the use of differential color schemes, “graying out” the call letters/names of locked channels (for example, as is often done in software application environments for menu selection items that are unavailable) or otherwise changing the channel cell text and/or background color for the locked channels and ratings as compared to the unlocked channels and ratings. FIGS. 5 and 6 also depict a preferred scroll bar layout wherein scroll bars 238 are provided on each side of the channel field (FIG. 5) or ratings field (FIG. 6), thereby reducing the need to shuttle the pointer back and forth across the display screen when making selections. Other graphical indicia may be employed to separate television and movie ratings, such as segregation of the television and movie ratings within the field (see, e.g., FIG. 8), the use of a separator bar between television and movie ratings, and so forth.

In FIGS. 4 and 6, the ratings applicable to television are illustrated by an optional TV icon 254 and the ratings applicable to motion pictures are identified by an optional motion picture icon 256. FIG. 8 illustrates an alternate content rating lock overlay 222″, which is similar to overlay 222′ shown in FIG. 6, but wherein a separate TV rating field 258 and movie rating field 260 are provided.

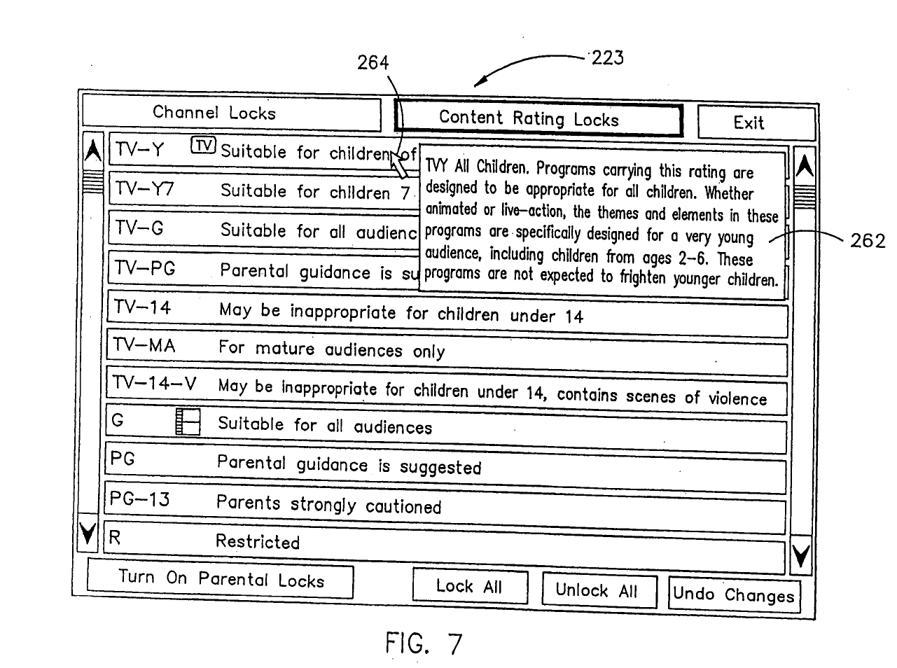

Additional features may also be provided in further embodiments of the present invention. For example, FIG. 7 depicts an embodiment where additional “context” information may be provided to the user. For example, a more detailed explanation of a particular rating may be obtained. FIG. 7 depicts content rating lock overlay 223 with a context information box 262 displayed. Such context information boxes may be accessed through a number of methods. In one embodiment, a user may control a pointer 264 so that it hovers or remains stationary over a particular content rating cell for a predetermined period of time. Upon hovering over a particular cell for the predetermined period of time, context information box 262 may be brought up containing information corresponding to the appropriate cell. In the illustration, the cursor is shown located over the TV-Y cell and, accordingly, additional information about the TV-Y rating is shown. In this manner, much more information than could readily fit on a single screen becomes rapidly accessible. In a variation, not shown, similar information may be provided through a context menu that is made available through a secondary mouse button event, i.e., by “right clicking” in a particular cell for which additional information is desired. A context menu so accessed displays the additional information in a pop up text box, either directly or as an item selectable from a menu including a “more information” menu selection item and also containing any number of additional features. Such additional features may include, for example, menu items for locking and unlocking the rating, and so forth. Also, detailed TV channel information (not shown) may be displayed for particular TV channel cells in the channel lock overlay in a similar manner.

In each of the above described embodiments, there has been described a parental lock interface wherein TV channel cells (FIGS. 3 and 5) or content rating cells (FIGS. 4, 6, 7, and 8) may be selected directly from the interface by a user and then applied to the various devices within the audiovisual system. In one embodiment, a more interactive interface and method for obtaining input from a user may be employed. Although the above described parental locks interface is intuitive, some users may prefer an interface which is even simpler and more automated. In one embodiment, a human oriented set of questions may be provided that asks about the individuals who will use the system and their ages. Questions may also be asked about the level of locking desired in general terms. In one embodiment, the questions can be posed in an interactive or wizard format wherein a series of questions are asked and wherein the answers to the questions dictate the subsequent questions. For example, such a questionnaire or wizard interface might begin by asking if any of the users of the system are children. If all of the users are adults, the program might then simply recommend that all devices be unlocked. On the other hand, if the user indicates that a child or children will be using the system, the wizard may then query as to the children's ages. After the children's ages are entered by the user, the wizard may then recommend locking all programming which correspond to the age of the youngest child. For, example, if a user indicates that there are children under the age of 13, the user interface could then suggest that all programs rated for audiences 13 and older be locked. The software would then apply a lock on all MPAA levels PG-13 and higher and lock all TV shows with a rating of TV-14 and higher.

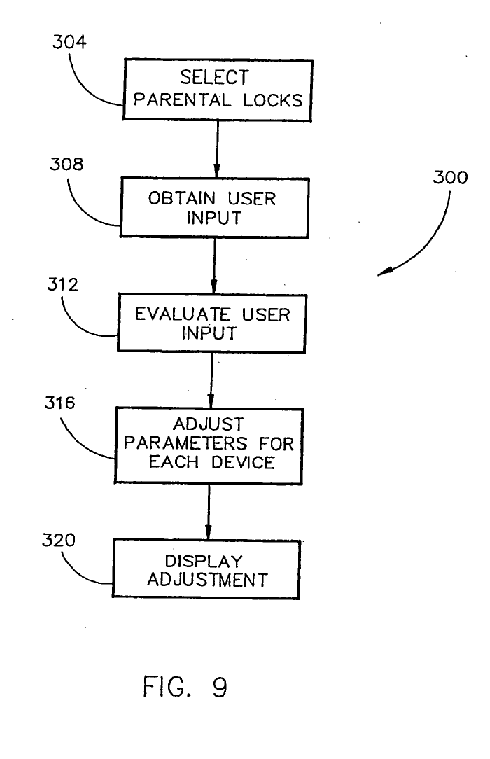

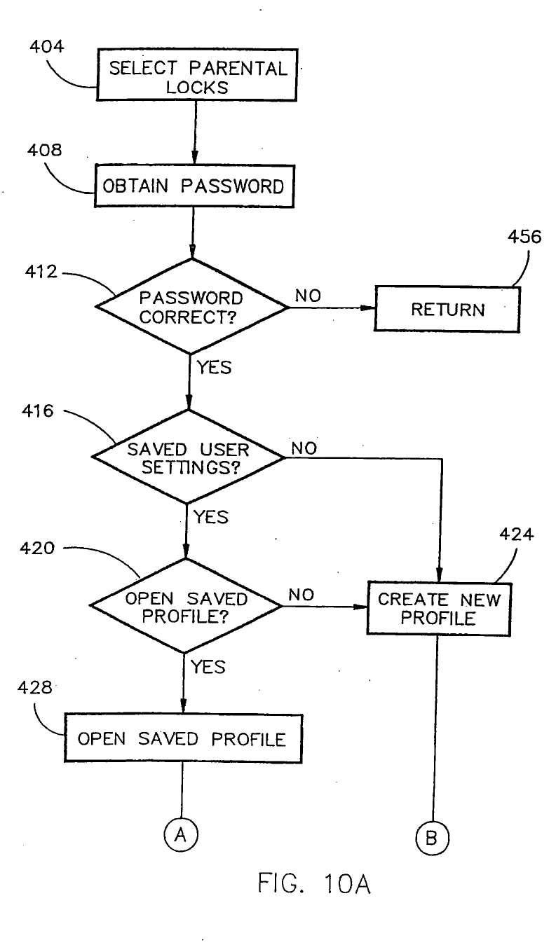

The method of establishing the results discussed above is summarized in flow chart form in FIG. 9. The flow chart 300 illustrates the methodology of the present invention in five basic steps. Specifically, the parental lock interface is selected by a user in step 304. This may be done by selecting the parental lock feature in an A/V device control panel, such as the control panel exemplified in FIG. 2. The user then uses the parental lock interface to select the material and/or channels to be locked in step 308. In step 312, the user input is then evaluated and converted to the equivalent or closest settings for each device that supports locks. The computer may textually or graphically display the level of parental locking selected in step 316, and, in step 320, adjust the parental locking parameter of each subsystem so that the operation of each of the parental lock subsystems is consistent with the user input of step 304.

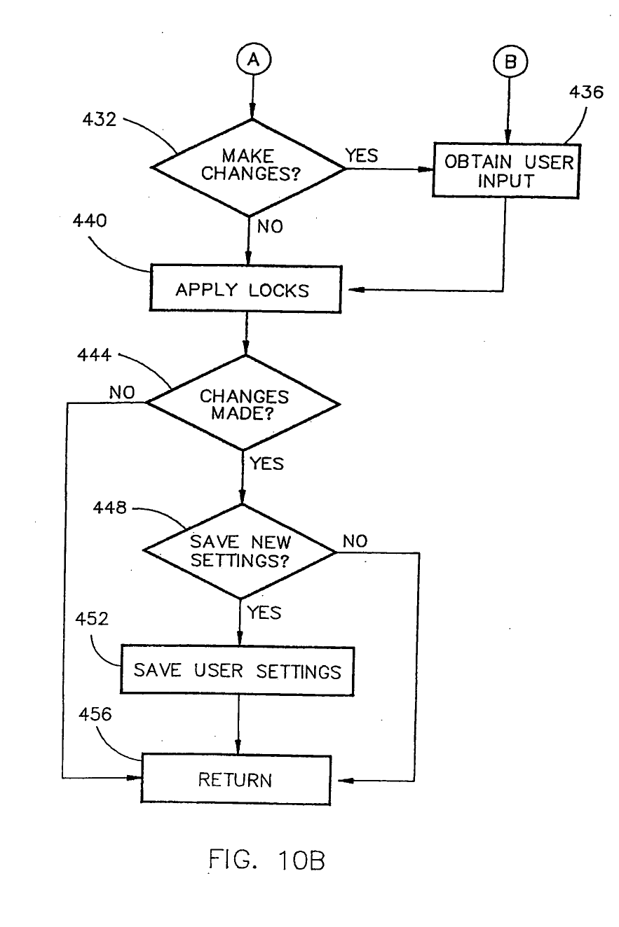

FIGS. 10A and 10B together illustrate a flow chart outlining a method wherein multiple user profiles may be created and saved in memory if desired. In step 404, the parental locks feature is selected, e.g., via button 208 (FIG. 2) from the A/V control panel 200 (FIG. 2). In step 408, a password is obtained. If the password determined to be incorrect in step 412, the process ends, for example, by returning to software application or overlay from which the parental locks feature was selected, such as an A/V control panel as depicted in FIG. 2. Alternatively, the process may allow one or more additional attempts at entering the password. It will be recognized that the password entry step may be at any other convenient point, such as when initially running an A/V control panel or other software environment that contains a link to the parental locks interface, or, after the parental locks interface is displayed but before any parental lock changes are actually made to the attached devices supporting parental locks. Other features designed to prevent tampering may also be included. For example, if incorrect passwords are entered a predetermined number of times, the system may be instructed to disable access to all A/V devices, preferably via a user selectable parameter. As an alternative or in addition to barring all access to the A/V features of the system, this information of attempts to breach the security may be reported to parents in the form of a data file, pop up message, and so forth.

Upon correct entry of the password in step 412, the system determines if there are any previously saved user settings or profiles in step 416. Previously saved user settings may be those previously saved by the user or they may be default settings for different age groups which may be used as a template which may be used and, if desired, modified in creating new profiles. If no saved user profiles are detected, the user may create a new user profile in step 424. In one embodiment, the new user profile may be generated by simply allowing the user to lock channels and content by manipulating the interface directly and then prompting the user whether to save the profile created as a data file which may simply be reloaded at a later time if subsequent changes are made. Where there are children of different ages, separate profiles could be selected for different children (or age groups). In one embodiment, a saved profile may also be associated with a particular user, for example, as where an operating system or other software application provides for defining a plurality of user profiles. Such operating system or application software typically allows different users to customize desktop appearance, allows or bars access to various data, software, or other features within a system, and so forth.

If there are previously saved user profiles, they may be displayed in step 420 and the user given an option of selecting one. The user may also be informed of which user profile is currently selected, if any, or other status of parental locks. If the user wishes to open a preexisting user profile in step, 420, the selected profile is opened in step 428. If previously saved user profiles exist, but the user wishes not to use any of them, the user may create a new profile in step 424.

If a preexisting user profile is opened in step 428 and the user simply wishes to use the settings without further changing them in step 432, the locks are applied to each device in step 440. If the user chooses to create a new user profile in step 424, the process proceeds to step 436 for user input. Likewise, if the user opens a preexisting profile with an intent to modify that profile, the process goes to step 436 and the user's input is obtained. After the user's input has been entered, the locks are applied in step 440.

In step 444, it is determined whether any changes were made, i.e., whether any new user profiles were created or whether any previously saved profiles were modified. If not the program terminates at step 456. In one embodiment, the user is returned to an A/V control panel. If changes were made (i.e., user input was obtained in step 436 either for the purpose of creating a new user profile or modifying an existing one), the user may then be prompted whether to save the changes in step 448. If saving the changes is not desired, for example, a new user profile was created for temporary, one-time use, or if a modification to an existing user profile is intended as a temporary, one-time change, the program exits to step 456 without saving the changes. If the user wishes to save any changes made or new profiles created, they are saved in step 452 before the program is exited in step 456.

In the above described process of FIGS. 10A and 10B, it will be recognized that the user input may be made by allowing the user to manipulate the user interface directly, with the process proceeding as the user makes selections. As an alternative, the input may be obtained in a more directed or interactive manner in the form of a questionnaire or wizard as described above.

Other features and embodiments are contemplated as well. For example, after setting the ratings locks for devices which support them, the system will notify the user of any device which does not support parental locks. The user could be informed of other content that may not or is likely to not carry ratings, such as many DVD titles currently on the market.

In the simplest embodiment, where a user selects a particular rating, that rating and all higher ratings will be locked. In a more flexible embodiment, the ratings may be selected individually. Preferably, the manner of operation in this regard may be selected by the user, e.g., in a user preferences options field.

Where extended TV ratings are selected, e.g., the software could recommend a setting and let the user know which devices support extended ratings and which do not. In one embodiment, individual ratings and rating variations are individually selectable. In another embodiment, if a user selects a general rating, such as TV-14, that rating and any variations thereof, such as TV-14-V, TV-14-S, TV-14-L, and TV-14-D will also be locked. In another embodiment, if a specific rating variation is selected, such as TV-14-V, then only that rating variation will be locked.

In one embodiment, since many programs still do not carry program ratings, the system could suggest that the user review the list of all television channels and identify and lock any networks that tend to show adult content. A list of television channels my also be suggested on the basis of user input, such as user responses to a wizard-type questionnaire as described above.

In one embodiment, personal remote control devices for specific users may be provided and associated with a specific user profile stored in the system. In this manner, the system can identify the remote control device used, determine the user associated with the identified remote control device, and apply the parental locks to each device according to the user profile associated with the remote control device.

The parental locks are not necessarily limited to TV ratings and movie content ratings. For example, a PC games lock feature may also be provided wherein a database of PC games may be provided having a MPAA or TV-type rating for each game. Such a games lock feature could automatically follow the locks set for broadcast and movie content. In one embodiment, a user may see a list of all titles installed on the system to explicitly lock any titles not contained in the database.

Similarly, the broadcast and movie ratings input may be also be used to configure installed Internet browsers or Internet filtering software.

In another embodiment, the locking system may be adapted to bar access by children or other unauthorized users to pay per view services, video on demand services, and so forth.

In yet another embodiment, to further facilitate the use of parental locks, the information regarding a user's parental control needs may be gathered and initiated by the manufacturer at the point of sale.

The present invention may be adapted to further enhancements in what is sure to be an ever-increasing technology. As advancements in A/V broadcast technologies are made and as mass storage capabilities are increased, it is likely that a further proliferation of parental control standards will occur. For example, rather than rating entire movies or programs, ratings of some materials, and thus the application of parental locks, may involve blocking of individual scenes rather than entire programs or movies. Likewise, as sufficiently large random access mass storage devices become available (or where transmission bandwidth would permit), parental control devices may involve scene replacement technology. For example, a movie, which with the exception of certain scenes may otherwise be acceptable for most viewers, may be stored (or broadcast) with alternative scenes containing different levels of violence, language, sex, acceptable for different age levels. As such, a parental control system may provide the option of allowing playback with acceptably rated scenes substituted for the original scenes. The present invention may be adapted to such standards as they may occur by providing a general, centralized interface.

The present invention provides a method of setting acceptable content rating parameters of a content control system capable of filtering content of ratings enabled media. Employing the present method, a user may adjust the acceptable content rating parameters of the content control system by blocking or unblocking example content. When such example content is blocked or unblocked, the content control system compares the rating of the example content with existing content rating parameters and adjusts the content rating parameters based on the rating of the example content. In this manner, the user may set the desired level of filtering of content without having specific knowledge of the content ratings scheme employed by the media, or the meaning of specific content ratings used by the content ratings scheme. Instead, the user need only decide whether the example content is acceptable or unacceptable for the protected audience. When one of two different programs having the same content rating is blocked in one instance and the second program having the same content rating is unblocked in another instance, the content control system can be designed to err on the conservative side by accepting the more stringent level of content blocking. Or, in an alternative embodiment, the content control system can be designed to look for patterns in the blocked and unblocked programs having similar content ratings. Thus, a distinction may be drawn between similar content ratings such as TV-Y, wherein TV-Y-V is deemed acceptable for viewing by children, and TV-Y-S is deemed unacceptable.

Content rating parameters delimit the content ratings threshold of content accessible by protected audiences. Protected audiences include users of information appliances providing access to the ratings enabled media who are prevented from accessing inappropriate content by the content control system. Exemplary ratings enabled media may include, but are not limited to, broadcast television, cable television services, pay-per-view services, video on demand services, digital satellite television services, DVD, video cassette, laserdisc, radio, cable music services, compact discs (CD), audio cassette tape, the Internet, intranets, and the like.

In specific embodiments, acceptable content rating parameters are often more commonly referred to by those skilled in the art, especially when applied to television media, as “parental lock levels” or “parental locks.” However, although exemplary embodiments of the invention will be described herein in terms of “parental control system,” “parental lock levels” or “parental locks,” it should be recognized that use of the word “parental” in such terms is intended to encompass any other person, in addition to parents who desire to prevent access of persons, and in particular children to inappropriate content. Such persons may include, but should not be limited to, administrators of computers or networks available to the public, such as in libraries, in church environments, on display in a retail environment, and so forth, or persons who display content where children may be present, such as in-flight movies displayed on an aircraft, and so forth.

Further, although the present invention will be described primarily in reference to television broadcast ratings (TV ratings) and MPAA motion picture ratings, it will be recognized that the present invention is not limited to the particular ratings systems described below. Other ratings include, for example, DVD ratings, electronic program guide (EPG) ratings such as Telstar, EchoStar, or other EPG systems, digital television (DTV) ratings, or any other ratings standards, as are now available or as may become available in the future. Reference will now be made in detail to presently preferred embodiments of the invention, examples of which are illustrated in the accompanying drawings.

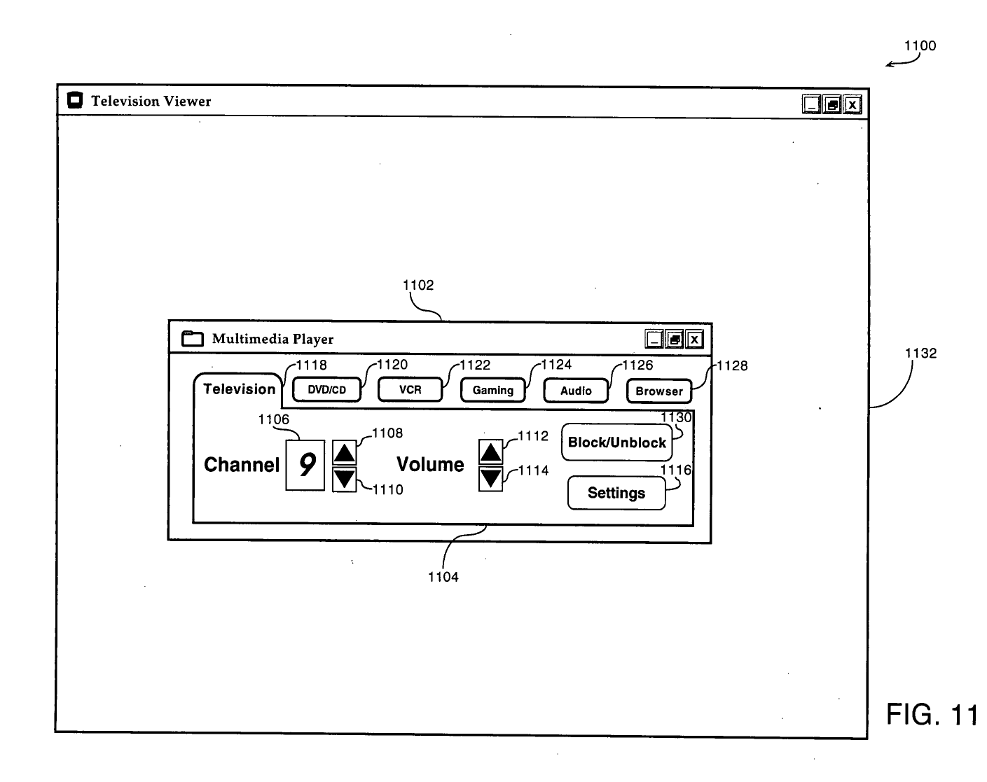

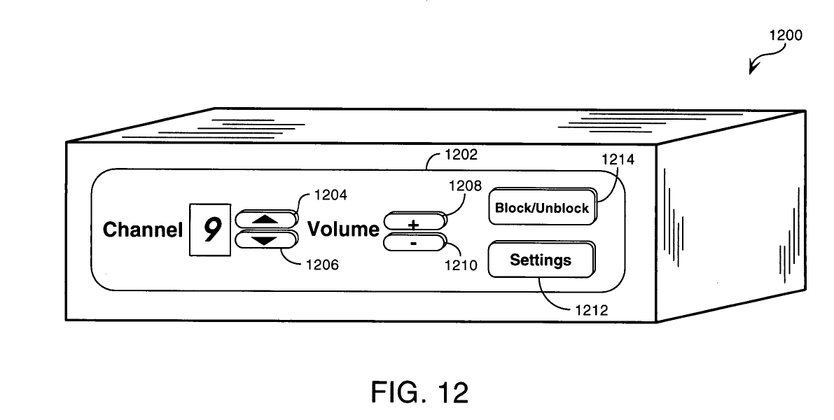

Referring now to FIGS. 11 and 12, exemplary user interfaces of information appliances implementing content control systems employing the present invention are described. As shown in FIG. 11, an exemplary user interface 1100 is displayed to the user by a display device of the information appliance. In one embodiment, such a user interface 1100 may include an on-screen control panel 1102 for controlling access to media by the information appliance (see FIG. 1). A region or window 1104 of the control panel 1 102 contains therein display fields such as “Channel” 1106 and various control buttons or switches such as channel selection 1108 & 1110, volume 1112 & 1114, “Settings” 1116 and so forth, which function as on-screen visual representations of controls of the information appliance or, alternately, peripheral devices attached thereto that provide access to one or more media.

Wherein multiple media may be accessed by the information appliance, the control panel may further provide controls for selecting a particular media to access. In the exemplary embodiment shown in FIG. 11, these controls comprise a series of buttons 1118, 1120, 1122, 1124, 1126 & 1128, which, when selected, change the contents of region or window 1104 so that the controls provided therein are suitable for controlling functions of the information appliance and/or peripheral devices used to access the media. Highlighting, color differentiation, or other visual indicia may be provided to show the media selected. It will be recognized that other means for selecting between and controlling provision of media accessed by the information appliance may be provided, including, but not limited to, menu hierarchies, pull down menus, pop-up lists, radio button or check box lists, and so forth.

In accordance with the present invention, the user interface 1100 further provides a control for providing an option to block or unblock the example content provided by the information appliance. For instance, as shown in FIG. 11, such a control is implemented in the region or window 1104 as a button 1130 labeled “Block/Unblock”. A user, wishing to block or unblock example content, selects the “Block/Unblock” button 1130 to initiate adjustment of the acceptable content rating parameters by the content control system as described more fully herein below.

As used herein, any on-screen graphical object which is described as a button or otherwise said to be selectable or otherwise accessed is intended to refer to on-screen objects which may advantageously be controlled with a pointing device such as a mouse or other device for controlling an on-screen pointer or cursor and generating mouse button events, although it will be recognized that many of such objects may also be made accessible through input via a keyboard, keypad, remote control device, or like input device as well.

The present invention may alternately be implemented physically as a control disposed on the housing of the information appliance providing the content control system. For instance, as shown in FIG. 12, an exemplary information appliance 1200, in this case peripheral device or “set-top box”, includes a control panel 1202 providing a user interface for controlling access of media provided to users of the appliance 1200. The control panel 1202 includes various control buttons or switches such as channel selection buttons 1204 & 1206, volume buttons 1208 & 1210, “Settings” button 1212, and so forth, which control functions of the information appliance 1200 and features of the media accessed thereby. In accordance with the present invention, the control panel 1202 further includes a control button 1214 (“Block/Unblock”) providing an option to block or unblock example content provided by the information appliance 1200. A user, wishing to block or unblock example content, depresses the “Block/Unblock” button 1214 to initiate adjustment of the acceptable content rating parameters by the content control system as described more fully below.

It will be recognized that user interfaces implementing the present invention are not limited to any particular design or layout, and that the control panels 1104 & 1202 of FIGS. 11 and 12 are provided merely to illustrate exemplary methods of providing convenient user access to content control systems implementing the present invention. Thus, any other method of accessing the content control system to adjust the system's acceptable rating parameters may be provided, including methods wherein access is provided via other software applications or the information appliance's operating system environment. For example, other control panel or media player software interfaces may be adapted to provide access to the generally applicable parental lock control in accordance with the present invention. Also, the present invention may also be implemented as a stand alone parental lock software application, utility, or control panel.

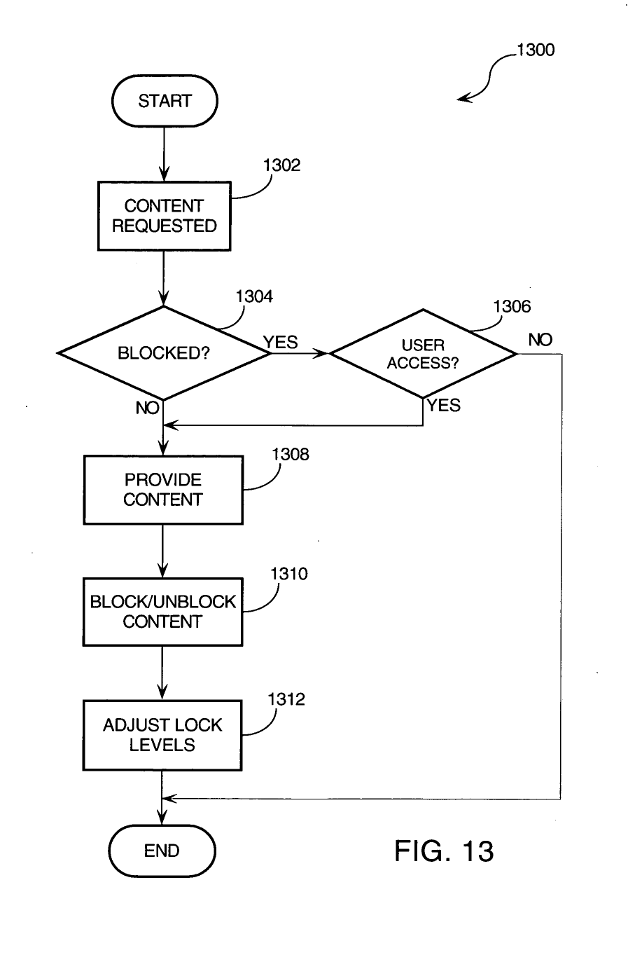

Referring now to FIG. 13, a method for adjusting the acceptable content rating parameters of a content control system in accordance with an exemplary embodiment of the present invention is shown. The method 1300 is initiated when a user requests content [hereinafter “example content”] from a ratings enabled media at step 1302. The example content may have associated therewith a content rating describing the nature of the content and its appropriateness for a particular audience such as young children. For instance, employing the user interface shown in FIG. 11, a user may choose to view a television program by accessing the control panel 1102 and selecting the button 1118 corresponding to a television viewing application thereby displaying controls for the application in region 1104. The user may then select a channel displaying the desired television program using channel selection buttons 1108 & 1110. The selected television program may have an associated content rating such as a TV parental guidelines rating or an MPAA rating.

The content control system, upon receiving the user request, determines if the example content is blocked at step 1304, for instance, because its content rating exceeds the rating threshold delineated by previously set acceptable content rating parameters of the content control system. For example, wherein the user has chosen to view a television program, that program's MPAA or TV rating may exceed a previously set parental lock level. Thus, wherein the television program has an associated TV rating of TV-PG and the parental lock level is set so that all television programs having TV ratings equaling or exceeding TV-PG (i.e., TV-PG, TV-14, and TV-MA ratings) are blocked, an example television program having a TV-PG, TV-14, or TV-MA rating would be blocked while a television program having a TV-Y, TV-Y7 or TV-G rating would not.

If the example content is blocked, the content control system may allow access to the example content at step 1306 by authorized users. In exemplary embodiments, such an authorized user may enter an access code, password or the like to access the blocked content. Thus, in the forgoing example, where the example television program is blocked, an authorized user, such as a parent, may view the program by entering his or her password. However, unauthorized viewers, such as children, who do not possess the necessary password could not.

Features designed to prevent tampering with the content control system to gain unauthorized access to content may also be included. For example, if incorrect passwords are entered a predetermined number of times, the system may be instructed to disable access to the media, preferably via a user selectable parameter. As an alternative, or addition, to barring all access to the media, attempts to breach the system may be reported to authorized users such as parents in the form of a data file, pop up message, and so forth.

Initially, the acceptable content rating parameters may be set either manually or through previous use of the present invention. For example, during initial use of the information appliance the acceptable content rating parameters may be set so that all content is passed, that is, no content provided by the appliance is blocked. The first time the user blocks example content, the acceptable content rating parameters of the content control system would be set to the content rating of the example content. As the user thereafter accesses additional example content, he or she may selectively block and unblock the content based on its subject matter adjusting the acceptable content rating parameters of the system. In this manner the acceptable content rating parameters could be adjusted or “fine tuned” to provide the desired level of filtering in a relatively short period. Alternately, the acceptable content rating parameters may be set by entering the acceptable content rating parameters of the content control system manually. A parental control system allowing such manual entry is described in commonly owned U.S. patent application Ser. No. 09/375,692 filed Aug. 17, 1999 by Gary E. Sullivan et al., which is herein incorporated by reference in its entirety.

Again referring to FIG. 13, if the example content is not blocked at step 1304, or, alternately, the user accesses the example content, for instance, by entering an access code or password at step 1306, the content control system allows the information appliance to provide the example content to the user at step 1308. The user, upon examining the example content provided at step 1308, may then decide to block content similar to the example content if it were unblocked or unblock the content similar to the example content if it was inappropriately blocked. Consequently, the user may command the content control system to block or unblock content similar to the example media at step 1310.

For example, in FIGS. 11 and 12, the user may select (or depress) the “Block/Unblock” buttons 1130 & 1214 provided by user interfaces 1100 & 1200. To prevent tampering with the content control system by members of the protected audience, exemplary embodiments may allow only authorized persons, for instance parents, library administrators, teachers, or the like to block and/or unblock content. For example, an authorized user may be required to enter an access code, password or the like to unblock blocked content.

Preferably, the user commands the content control system to block or unblock the example content at any time during or after accessing (e.g., viewing or listening to) the content, provided additional example content has not been requested. However, in a more flexible embodiment, the content control system may store the identification and content rating of example content provided to the user. In this manner, the user may thereafter choose to block or unblock that content, for instance, after viewing additional content, or before turning off the information appliance providing the content by recalling the identification of the example content from the memory whereupon the content control system may be commanded to block or unblock content similar to the example content. Similarly, in one embodiment, the present invention may allow the user to block or unblock example content without first viewing the content. For example, the user may have prior knowledge of the example content and may wish to adjust the acceptable content rating parameters so content similar to the example content is blocked or unblocked without again viewing the content.

If the user chooses to block or unblock content similar to the example content at step 1310, the acceptable content rating parameters are adjusted, at step 1312, based on the content rating of the example content. The content control system compares the content rating of the example content to the existing acceptable content rating parameters and modifies the acceptable content rating parameters based on the comparison. The acceptable content rating parameters may then be used to provide a content rating threshold for blocking future access to the example content and any content having ratings similar to the example content.

In further examples of the present invention, the content control system may utilize multiple acceptable content rating parameters providing content rating thresholds for media using different rating schemes. When a user views example content in a first media using a first rating scheme and blocks or unblocks the example content causing the system to adjust the acceptable content rating parameter for that media, the acceptable content ratings parameters for media using other ratings schemes may also be adjusted accordingly. This adjustment may be accomplished, in one embodiment, by equating ratings of the various rating schemes utilized by the media. For instance, wherein the media is television employing both the TV parental guideline and MPAA ratings schemes, a TV rating of TV-G may be equated to an MPAA rating of G, a TV rating of TV-PG may be equated to an MPAA rating of PG, and so forth. However, it will be appreciated that the ratings used by one ratings scheme may not necessarily correspond one for one with the ratings used by a second ratings scheme. In such cases, a given rating in one scheme may usually be equated to a more restrictive rating in a second scheme. Thus, in the proceeding example, a TV-rating of TV-14 may be equated to the slightly more restrictive MPAA rating of PG-13, while a TV-rating of TV-MA may be equated to the more restrictive MPAA rating of R. Thus, wherein an information appliance is capable of accessing multiple media, for example, television, DVD movies, VCR movies, the Internet, and the like, a user may adjust the acceptable content rating parameters for each media based on example content of any one media even though each of the media may employ different ratings schemes.

Referring now to FIGS. 11, 14A, 14B and 15, an exemplary embodiment of the present invention is shown wherein the media is television. In such an embodiment, the information appliance may include a television tuner employing a content control system more commonly referred to in the art as a “parental control system” for filtering content provided by the information appliance. When a user such as a parent has requested a television program, and that program is not blocked by the parental control system, the information appliance is capable of displaying the television program within a television viewer region or window of the user interface. The parent, upon viewing the program, may decide that the program contains subject matter that is inappropriate for a protected audience, such as young children. For instance, the television program may contain graphic violence or sexual themes to which the parent does not want his or her children exposed.

Consequently, the parent may wish to block access to the television program and other television programs having similar content. As shown in FIG. 11, the parent selects the “Block/Unblock” button 1130 provided in region 1104 thereby commanding the parental control system to block the example television program. Alternately, if the parent has requested a television program, and that program is blocked by the parental control system, the parent may enter a password to override the block and view the program. The information appliance may then display the television program within the television viewer region or window 1132 of the user interface 1100. If the parent thereafter determines that the television program was inappropriately blocked, depressing the “Block/Unblock” button 1130 will unblock the television program and all similar programs. Again, as discussed more fully above, in exemplary embodiments, the parent may select the “Block/Unblock” button 1130 at any time after selecting the television program; i.e., prior to or instead of viewing the program, while viewing of the program, or after viewing the program.

When the parent selects the “Block/Unblock” button 1130, the information appliance compares the existing acceptable content rating parameters to the rating of the television program and adjusts them accordingly. For example, wherein the television parental control system utilizes the standard TV parental guideline rating scheme, the acceptable content rating level, more commonly referred to as the “parental lock level” may be set at TV-14. The parent viewing a television program having a TV-PG rating may decide that the content of the television program is not acceptable for viewing by audiences including younger children. The information appliance, upon receiving user input to block or unblock the television program via selection of the “Block/Unblock button 1130, compares the existing parental lock level (TV-14) with the rating of the example program (TV-PG). Since the existing parental lock level is less restrictive than the rating of the example program (TV-PG), the information appliance adjusts the parental lock level to equal the content rating of the television program. In this case, the parental lock level is adjusted from TV-14 to TV-PG. Thereafter, all television programs having content ratings equal to or exceeding TV-PG would be blocked by the parental control system.

Similarly, a parent viewing a blocked television program, for example, a television program having a TV-G rating wherein the parental lock level is set at TV-Y, may find that the program is not objectionable and is therefore inappropriately blocked. The parent may unblock the television program by selecting the “Block/Unblock” button 1130 whereupon the information appliance compares the existing parental lock level (TV-Y) with the rating of the example program (TV-G). Since the existing parental lock level is more restrictive than the rating of the television program (TV-G), the information appliance adjusts the parental lock level to equal the rating of the television program, that is the parental lock level is adjusted from TV-Y to TV-PG. Thus, only television programs having content ratings equal to or exceeding TV-PG would be blocked by the parental control system, whereas programs with TV-G, now deemed acceptable, would no longer be blocked.

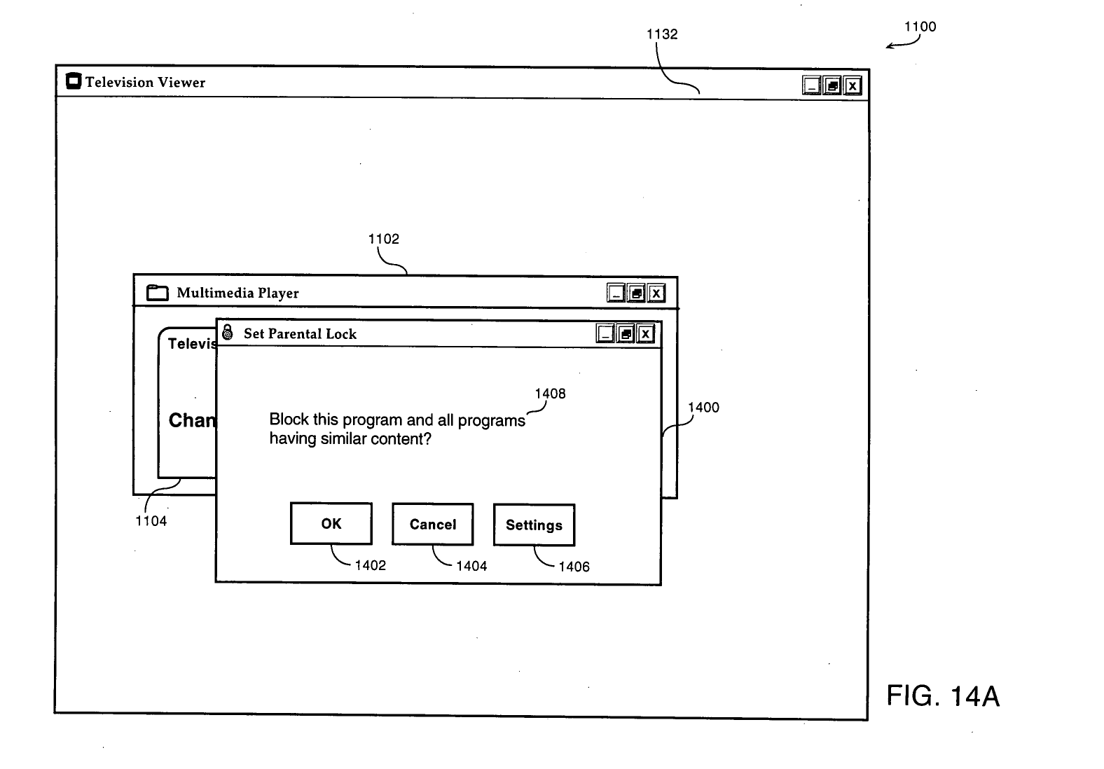

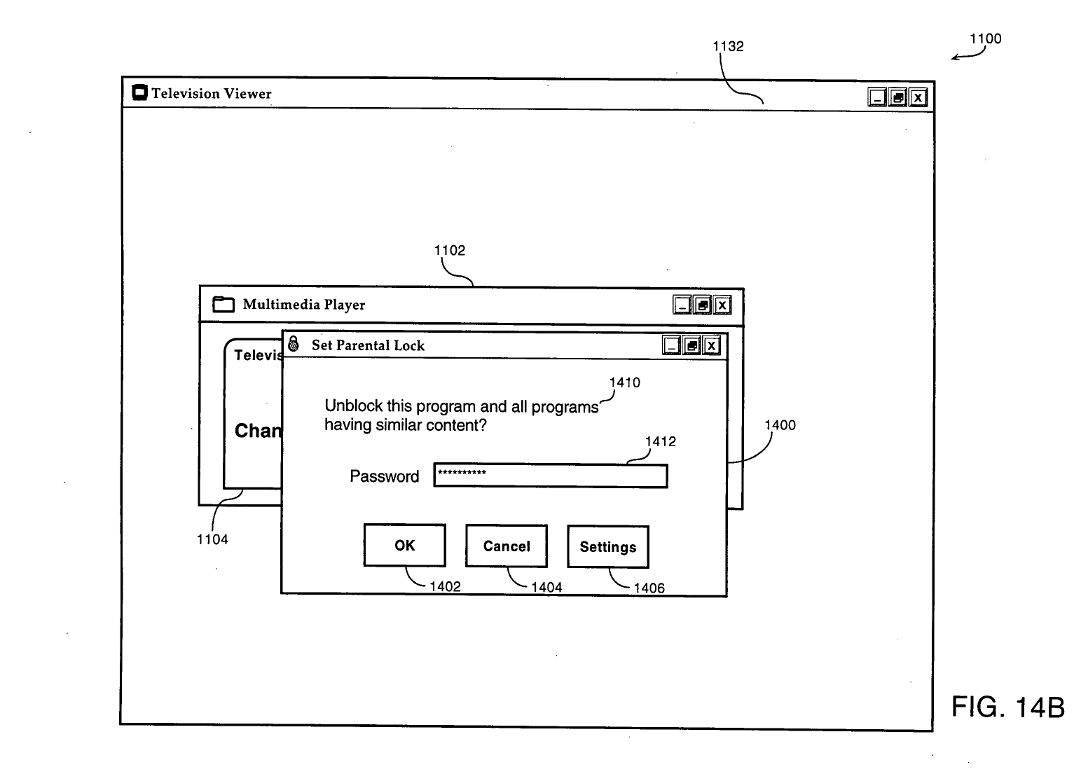

In exemplary embodiments of the invention, when the user selects the “Block/Unblock” button 1130, a request for confirmation of the selection may be provided to the user before adjusting the acceptable parental lock levels of the parental control system. Thus, as shown in FIGS. 14A and 14B, the information appliance may display a parental lock confirmation region or window over the television viewing window for requesting confirmation that the user wishes to block or unblock television programs similar to the program being viewed. The confirmation window 1400 may include a button (“OK”) 1402, which when depressed, confirms the original selection of the “Block/Unblock” button 1130 (FIG. 11). Likewise, a second button (“Cancel”) 1404 may be provided allowing the user to cancel his or her selection of the “Block/Unblock” button 1130 and return to the television viewing window 1132 without adjusting the parental lock levels. Additionally, a button (“Settings”) 1406 may be provided for allowing the user to access the content control system settings, to, for example, view the existing acceptable content rating parameters.

If the television program was unblocked, selection of the “Block/Unblock” button 1130 (FIG. 11) will adjust the parental control system's parental lock levels so as to block the television program and television programs having similar content. Thus, as shown in FIG. 14A, the confirmation window 1400 displays a request (“Block this program and all programs having similar content?”) 1408 that the user confirm that he or she wishes the example program and all programs having similar content to be blocked in the future. Alternately, if the user determines that the example program was inappropriately blocked, depressing the “Block/Unblock” button 1130 (FIG. 11) will unblock the example program and all similar programs. Thus, as shown in FIG. 14B, the confirmation window 1400 would provide a request (“Unblock this program and all programs having similar content?”) 1410 asking the user to confirm that the example program and allow programs having similar content are to be unblocked. The confirmation window 1400 may further include a field 1412 requiring the user to enter a password to prevent tampering with the parental control system by members of the protected audience.

In an exemplary embodiment of the invention, multiple user profiles may be created and stored for individual users or groups of users. Each user profile may have individual acceptable content rating parameters set specifically for that user or group of users. Thus, a young child may have more restrictive acceptable content rating parameters than would a teen-aged child, who may, in turn, have more restrictive acceptable content rating parameters than would an adult. Likewise, a user group consisting of children may have more restrictive acceptable content rating parameters than a user group consisting of parents.

An authorized user, such as a parent, may generate user profiles by entering a user identification for each user via the user interface and thereafter adjusting the acceptable content rating parameters for that user base on example content. Each user would thereafter enter his or her user identification via the user interface to access content via the information appliance. Alternately, in one embodiment, personal remote control devices for specific users may be provided and associated with a specific user profile stored in the system. In this manner, the system can identify the remote control device used, determine the user associated with the identified remote control device, and apply the parental locks to each device according to the user profile associated with the remote control device.

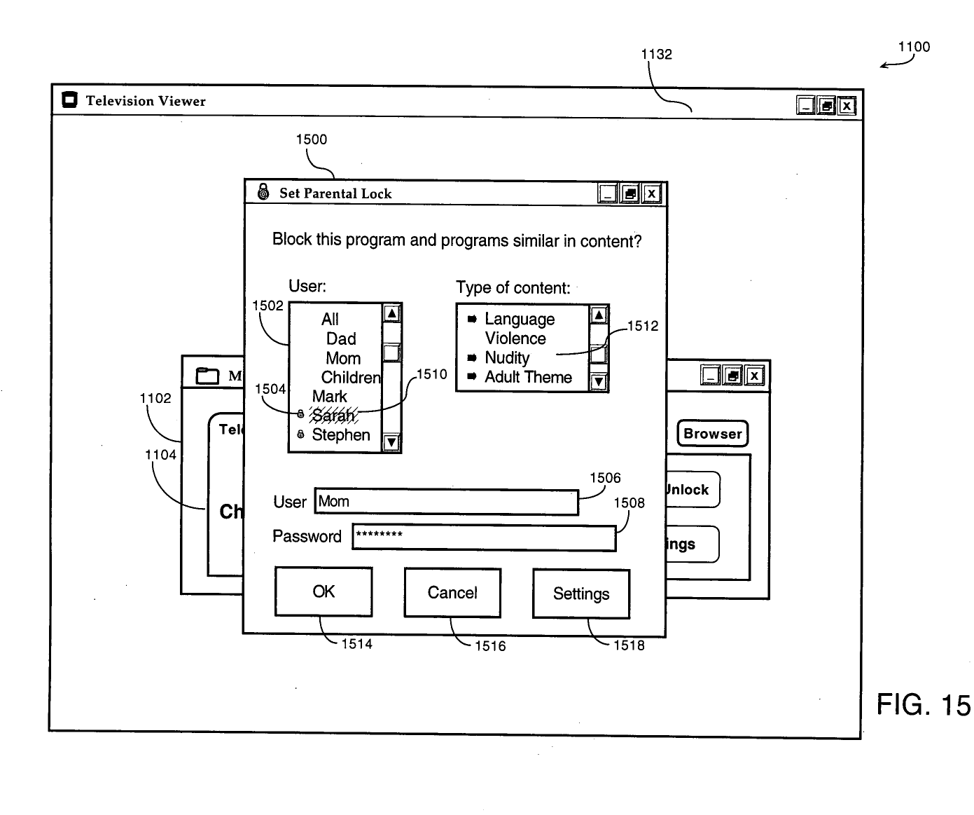

An exemplary confirmation region or window for a multiple user profile embodiment is shown in FIG. 15. When an authorized user, such as a parent (“Mom”) selects the “Block/Unblock” button 1130 (see FIG. 11), the confirmation window 1500 is displayed by the information appliance, for example, over the television viewing window 1132. The confirmation window 1500 allows the authorized user to adjust the parental lock levels of the parental control system for each user or group of users. For instance, in the embodiment shown in FIG. 15, a field 1502 may be provided allowing the authorized user (“Mom”) to select users (e.g., “Dad”, “Mom”, “Mark”, “Sarah”, “Stephen”) and/or groups of users (e.g., “All”, “Children”) for which for which television programs similar to the television program currently being viewed are to be blocked in the future. The parental lock levels for that user or group of users are then adjusted in accordance with the present invention by comparing the rating of the television program with the existing parental lock levels for that user or group of users and adjusting the parental lock levels accordingly. The confirmation screen 1500 may also provide a way of indicating which users or user groups have been selected for adjustment. For instance, in the embodiment shown in FIG. 15, indicia 1504, in this case a representation of a lock, are displayed adjacent to the user's or group's name to indicate that that user has been selected for blocking of programs similar to the example television program. The confirmation window 1500 may further include fields 1506 & 1508 requiring the user to enter a user identification, for example, a user name and password to verify that the user making the changes is authorized to do so.

In a further exemplary embodiment, the acceptable content rating parameters may also be set according to content theme, wherein the ratings scheme allows content of the media to be distinguished according to content theme. Thus, a user viewing content such as a television program may determine that specific content themes presented by the program, such as for example, nudity and sexual content, are objectionable. As a result, the user may wish to block the example program and other programs having content themes similar to the objectionable themes in the example program. For example, wherein the media is television, each television program may utilize TV Parental Guideline rating scheme ratings (TV-Y, TV-Y7, TV-G, TV-PG, TV-14, TV-MA) that further include content theme indicators such as a “fantasy violence” (FV) indicator that may be added to the TV-Y rating, and indicators for violence (V), sexual situations (S), language (L), and dialog (D), may be added to each of the TV-PG, TV-14, and TV-MA ratings. The content control system, in this case a parental control system, may store these indicators as part of its parental lock levels to block specific television programs containing unacceptable themes. Thus, in one embodiment, the parental lock levels may be set to TV-PG-V, TV-14-L, and TV-G-S so that television programs having ratings equal to or exceeding TV-PG for violence, TV-14 for language, and/or TV-G for sexual situations are blocked.

As shown in FIG. 15, to adjust parental lock levels for a specific user or group of users, an authorized user such as a parent (“Mom”) may first select a user profile, in this case a child identified as “Sarah” 1510, and then select content of the example program that is objectionable for that user, i.e., “Language”, “Nudity”, “Adult Theme” from field 1512. The parent may select content themes of the example program to be blocked or passed for each user profile to be adjusted. The parent may then select the “OK” button 1514 whereupon the parental lock levels for the altered user profiles are adjusted accordingly. In this manner, television programs having content theme ratings similar to the content theme ratings of the example television program for the content themes found to be objectionable are blocked. As an additional means of parental control, the parent may be given the option of completely blocking certain themes, such as violence, regardless of the content theme rating of a given program. This feature would override the block/unblock access determined via the selection of example content of the present invention. Alternately, the parent may select the “Cancel” button 1516 to cancel his or her changes and return to the television window 1132 without adjusting the parental lock levels. Additionally, a button (“Settings”) 1518 may be provided for allowing the user to access the content control system settings for each user profile, to, for example, view the existing parental lock levels.

The present invention may be adapted for further enhancements in what is sure to be an ever-increasing technology. As advancements in media technologies are made and as mass storage capabilities are increased, it is likely that a further proliferation of content control standards will occur. For example, rather than rating entire movies or programs, ratings of some materials, and thus the application of content rating parameters, may involve blocking of individual scenes rather than entire programs or movies. Likewise, as sufficiently large random access mass storage devices become available (or where transmission bandwidth would permit), content control devices may involve scene replacement technology. For example, a movie, which with the exception of certain scenes may otherwise may be acceptable for most viewers, may be stored (or broadcast) with alternative scenes containing different levels of violence, language, sex, acceptable for different age levels. As such, a content control system may provide the option of allowing playback with acceptably rated scenes substituted for the original scenes. The present invention may be adapted to such standards as they may occur by providing a means of easily adjusting the content ratings parameters for such content control systems.

The present invention may be implemented as sets of instructions resident in memory of one or more information appliances configured generally as described in FIG. 1. For example, in an exemplary embodiment, the present invention may be implemented as an ancillary program of instructions or “plug in” for a parental control system application employed by the information appliance. Until required by the information appliance, the set of instructions may be stored in another readable memory device, for example in a hard disk drive or in a removable memory such as an optical disk for utilization in a DVD-ROM or CD-ROM drive, a magnetic media for utilization in a magnetic media drive, a magneto-optical disk for utilization in a magneto-optical drive, a floppy disk for utilization in a floppy disk drive, a floptical disk for utilization in a floptical drive, a personal computer memory card for utilization in a personal computer card slot, or the like. Further, the set of instructions can be stored in the memory of another information appliance and transmitted over a local area network or a wide area network, such as the Internet, an intranet, or the like, when desired by the user. Additionally, the instructions may be transmitted over a network in the form of an applet that is interpreted or compiled after transmission to the computer system rather than prior to transmission. One skilled in the art would appreciate that the physical storage of the sets of instructions or applets physically changes the medium upon which it is stored electrically, magnetically, chemically, physically, optically or holographically so that the medium carries computer readable information.

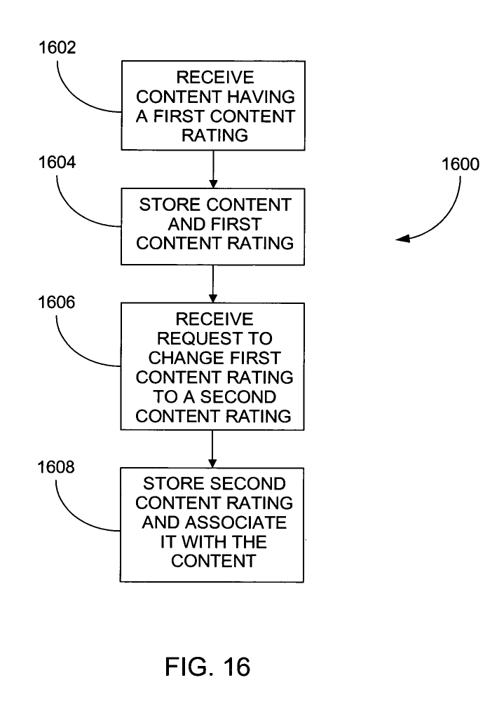

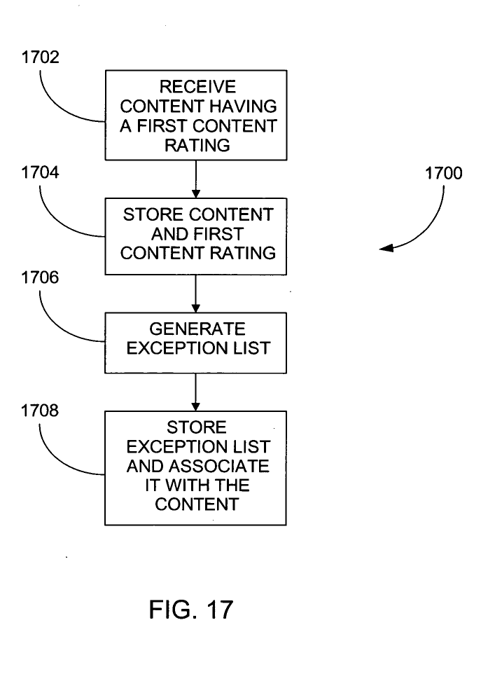

Referring generally to FIGS. 16 and 17, a content recorder in accordance with an exemplary embodiment of the present invention is described. The content recorder may include a television set, a DVD, a VCR, a personal video recorder (PVR), a PC-TV, a convergence system, or the like for recording and/or outputting an audio/video signal. In preferred embodiments of the present invention, an authorized user of the content recorder (e.g. a parent or guardian) may alter a rating of recorded audio/visual content. For example, using the broadcast television rating system, content having a TV-14 rating may be altered to have a TV-PG rating. Alternately, the content having the TV-14 rating may be altered to have a TV-MA rating. Those of ordinary skill in the art will appreciate that the present invention is not limited to the television rating system, however, and may be used for altering any type of rating information stored in combination with audio/visual content, such as an MPAA rating, a game rating, or the like.

Altering a rating of audio/visual content in accordance with exemplary embodiments of the present invention may be accomplished in a number of different ways. Preferably, a PVR including a storage medium such as a hard disk drive or the like is used to receive and display television content, such as from a television receiver or the like. The present invention allows an authorized user of the PVR to alter a rating associated with the received television content. In one embodiment, the PVR may store the television content in a compressed form, such as an MPEG-2 format or the like. The rating associated with this television content may be stored with the television content or in a separate physical location within the storage medium of the PVR. The rating of the television content is then altered by changing a rating associated with the television content in the storage medium, e.g. changing a stored representation of a TV-14 rating to a stored representation of a TV-PG rating within the storage medium of the PVR.

Referring now to FIG. 16, a method for controlling access to content 1600 in accordance with exemplary embodiments of the present invention is described. In step 1602, content having a first content rating is received. For example, a television program having a first broadcast television content rating is received by a PVR. Next, in step 1604, the content and the associated first content rating are stored, e.g. the television program is saved by the PVR on a hard disk drive. Then, in step 1606, a request is received to change the first content rating to a second content rating. For instance, the PVR receives a request to alter the first content rating of the television program to a second content rating. Finally, in step 1608, the second content rating is stored and associated with the stored content for controlling access to the content, e.g. the second content rating is associated with the television program stored by the PVR.

In another embodiment, a content recorder in accordance with the present invention such as a PVR, a VCR, or the like may store the television content in an uncompressed form, retaining rating information as part of the stored television signal. To alter the rating of the television content, an authorized user instructs the content recorder to change the rating information stored with the television content, e.g. replacing a TV-14 rating found in a vertical blanking interval of the stored television signal with a TV-MA rating.

Because permanently altering a stored television signal may be undesirable, a PVR in accordance with an exemplary embodiment of the present invention may include a unique password for a user or a group of users. For example, a seven year old child may have one password (or alternately no password and a default restriction level), while a thirteen year old may have another password. An authorized user (e.g. a parent or guardian) may allow another user (e.g. the thirteen year old child) to view an instance of audio/visual content stored by the PVR which may ordinarily be blocked from the user's view. For instance, the thirteen year old may be allowed to access a previously recorded television program rated TV-14. A list of users allowed to view a specific instance of audio/visual content for which they may not ordinarily have access to is maintained by the PVR. The list may be updated by authorized users. It should be noted that such a list may apply to a single instance of audio/visual content or alternately to multiple instances of similar content, such as a television series.

Referring now to FIG. 17, a method for controlling access to content 1700 in accordance with exemplary embodiments of the present invention is described. In step 1702, content having a content rating is received. For example, a television program having a broadcast television content rating of TV-14 is received by a PVR. Next, in step 1704, the content and the associated content rating are stored, e.g. the television program and the TV-14 rating are saved by the PVR on a hard disk drive. Then, in step 1706, an exception list associated with the content is generated, denoting at least one user who is allowed to access the content and who would otherwise be blocked by application of the content rating. For instance, the PVR receives a request from an authorized user (e.g. a parent or guardian) to add a thirteen year old to a list of users allowed to watch the TV-14 rated television program. Finally, in step 1708, the exception list is stored and associated with the stored content for controlling access to the content, e.g. the exception list including the thirteen year old is associated with the television program stored by the PVR.

Those of ordinary skill in the art will appreciate that the content recorder of the present invention may serve to prevent unauthorized users from viewing restricted content in a number of ways. In the exemplary embodiment, the content recorder may prevent restricted content from being transferred to a content viewing device, such as a television set or monitor. In another embodiment, however, the content recorder may alter the rating information of the restricted content and send it to the viewing device or a second content recorder. In such an instance, the viewing device or second content recorder should be enabled to block content bearing the restrictive rating information. It should be noted that a number of different methods may be used to alter, transmit, and retransmit audio/visual content without departing from the scope and intent of the present invention.

Although the invention has been described with a certain degree of particularity, it should be recognized that elements thereof may be altered by persons skilled in the art without departing from the scope and spirit of the invention. It is understood that the specific orders or hierarchies of steps in the methods disclosed are examples of an exemplary approach. Based upon design preferences, it is understood that the specific order or hierarchy of a method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

1. A method for controlling access to content, comprising: receiving content having a first content rating associated therewith for controlling access to the content;
storing the content and the associated first content rating;
receiving a request to change the first content rating to a second content rating; and
storing the second content rating so that the second content rating is associated with the content for controlling access to the content.

2. The method as claimed in claim 1, further comprising blocking access to the content using the second content rating.

3. The method as claimed in claim 1, wherein the step of receiving the request to change the first content rating to the second content rating comprises determining if a user making the request has authority to make the request.

4. The method as claimed in claim 3, wherein the step of determining if the user making the request has authority to make the request comprises receiving a personal identification code entered by the user.

5. The method as claimed in claim 1, wherein the content rating is comprised of at least one content theme rating.

6. The method as claimed in claim 1, wherein the content comprises a motion picture.

7. The method as claimed in claim 1, wherein the content comprises a computer game.

8. The method as claimed in claim 1, wherein the content comprises a site within a network.

9. The method as claimed in claim 1, wherein content comprises at least one of a song and a compilation of songs.

10. A video recorder, comprising:
a receiver for receiving content having a first content rating associated therewith for controlling access to the content;
a memory for storing the content and the associated first content rating; and
a controller for receiving a request to change the first content rating to a second content rating,
wherein the second content rating is stored so that the second content rating is associated with the content for controlling access to the content.

11. The video recorder as claimed in claim 10, wherein access to the content is blocked using the second content rating.

12. The video recorder as claimed in claim 10, wherein the controller determines if a user making the request has authority to make the request.

13. The video recorder as claimed in claim 12, wherein the controller receives a personal identification code entered by the user.

14. The video recorder as claimed in claim 1, wherein the content rating is comprised of at least one content theme rating.

15. The video recorder as claimed in claim 1, wherein the content comprises a motion picture.

16. A method for controlling access to content via a video recorder, comprising:
receiving content having a content rating associated therewith for controlling access to the content by users of the video recorder;
storing the content and the associated content rating;
generating an exception list associated with the content for denoting at least one user who is allowed to access the content and who would otherwise be blocked by application of the content rating; and
storing the exception list with the content and the associated content rating.

17. The method as claimed in claim 16, further comprising blocking access to the content using the content rating and the exception list.

18. The method as claimed in claim 16, wherein the step of generating the exception list comprises determining if a person generating the exception list has authority to generate the exception list.

19. The method as claimed in claim 18, wherein the step of determining if the person generating the exception list has authority to generate the exception list comprises receiving a personal identification code entered by the person.

20. The method as claimed in claim 16, wherein the content rating is comprised of at least one content theme rating.

21. The method as claimed in claim 16, wherein the content comprises a motion picture.

22. A video recorder, comprising:
means for receiving content having a first content rating associated therewith for controlling access to the content;
means for storing the content and the associated first content rating; and
means for receiving a request to change the first content rating to a second content rating,
wherein the second content rating is stored so that the second content rating is associated with the content for controlling access to the content.

23. A method of setting a threshold content rating of a content control system based on example content for filtering content of media provided by an information appliance, comprising:
receiving user input to block or unblock future access to content similar to example content presented to a user; and
adjusting the threshold content rating of the content control system based on the content rating of the example content;
wherein the information appliance compares the content rating of the example content to the threshold rating and adjusts the threshold rating based on the comparison to control future access to content similar to the example content.

24. The method of setting a threshold content rating as claimed in claim 23, further comprising allowing user input to unblock future access to content similar to the example content if the user has authority to unblock further access to such similar content.

25. The method of setting a threshold content rating as claimed in claim 24, wherein determining if the user has authority to unblock further access to content similar to the example content comprises receiving a user identification.

26. The method of setting a threshold content rating as claimed in claim 23, further comprising determining if the user has authority to block further access to content similar to the example content.

27. The method of setting a threshold content rating as claimed in claim 26, wherein determining if the user has authority to block further access to content similar to the example content comprises receiving a user identification.

28. The method of setting a threshold content rating as claimed in claim 23, wherein the threshold content rating comprises at least one user threshold content rating defining the content rating level acceptable for a particular user, further comprising adjusting the user threshold content rating for a particular user.

29. The method of setting. a threshold content rating as claimed in claim 23, wherein the content rating is comprised of at least one content theme rating.

30. The method of setting a threshold content rating as claimed in claim 23, wherein the media comprises television and the content comprises television programs.

31. The method of setting a threshold content rating as claimed in claim 23, wherein the media comprises computer gaming and the content comprises computer games.

32. The method of setting a threshold content rating as claimed in claim 23, wherein the media comprises a network and the content comprises sites within the network.

33. The method of setting a threshold content rating as claimed in claim 23, wherein the media comprises music and the content comprises at least one of a song and a compilation of songs.

34. A system for controlling a plurality of parental control subsystems in an audio/visual system, said system configurable by a graphical user interface (GUI), comprising:
a computer having a memory and a display exhibiting a GUI;
one or more audio and/or audiovisual devices interfaced to said computer, wherein at least one of said audio and/or audiovisual devices comprises a native parental control subsystem having adjustable parameters;
control programming which operates the computer to receive user input, said user input allowing a user to choose one or more general parental control parameters; and
control programming which operates the computer to set the adjustable parameters of each native parental control subsystem within said system.
